(19) United States
(12) Patent Application Publication
(10) Pub. No.: US 2006/0216131 A1
(43) Pub. Date: Sep. 28, 2006

(54) Apparatus and method for prevention of interferences from speech sounds in telephony

(75) Inventor: Yun-shiang Jhuang, Taipei City (TW)

Correspondence Address: BIRCH STEWART KOLASCH & BIRCH, PO BOX 747, FALLS CHURCH, VA, 22040-0747, US

(73) Assignee: INVENTEC MULTIMEDIA & TELECOM CORPORATION, Taipei City (TW)

(21) Appl. No.: 11/087,658

(22) Filed: Mar. 24, 2005

(51) Int. Cl. F16B 37/04

(52) U.S. Cl. 411/181

(57) ABSTRACT

Disclosed is an apparatus and method for prevention of interferences from speech sounds in telephony. The apparatus comprises a cipher generation unit, an automatic speech sound sending digital processor and an incoming call filter unit. When a receiver receives an incoming call from a sender, a cipher is generated. Next, the receiver sends a speech sounded cipher to the sender based on the generated cipher. Responsive to the speech sounded cipher, the sender inputs a response cipher with reference to the speech sounded cipher. Finally, the inputted cipher and the cipher generated at the receiver end are compared, so that the receiver may determine if the incoming call is a voice-over-internet protocol (VOIP) SPAM and should be answered.

### BACKGROUND OF THE INVENTION

1. Field of Invention

The present invention relates to an incoming alarm apparatus and method, particularly to an apparatus and method for prevention of interferences from an incoming call in telephony.

2. Related Art

Since computer telephony integration (CTI) and voice-over-internet protocol (VOIP) technologies have been gradually used, telephone costs may be greatly reduced. It may be anticipated that currently prevailing Email SPAM through which advertisement is spread out may be largely replaced with VOIP SPAM. Through the VOIP SPAM, a large amount of audio advertisement for various activities may be spread out at a low cost, such as for vote request and telephony marketing.

Between the Email SPAM and the VOIP SPAM, a main difference resides in their prevention mechanism. In prevention of the Email SPAM, emails are determined if they are Email SPAM based on information of their senders, titles, contents and the like. However, the VOIP SPAM may be known only after the call is received. Therefore, there is a need to provide an active filtering mechanism for such VOIP SPAM so that the VOIP SPAM sent by a machine or a computer may be filtered out previously. The possibility of such VOIP SPAM interferences may be considerably reduced.

### SUMMARY OF THE INVENTION

It is, therefore, an object of the present invention to provide an apparatus for prevention of interferences from speech sounds in telephony. The apparatus comprises a cipher generation unit adapted to generate a cipher based on an incoming call from a sender end, an automatic speech sound sending a digital processor adapted to play a cipher speech sound to the sender end and an-incoming call filter unit adapted to compare a cipher inputted by the sender end with the cipher generated at the receiver end, so that the receiver end may determine if the incoming call is a voice-over-internet-protocol (VOIP) SPAM and should be answered.

It is another object to provide a method for filtering of VOIP SPAM in telephony, comprising the steps of generating a cipher in response to an incoming call made from a sender end; sending a speech sounded cipher at the receiver end to the sender end based on the generated cipher; inputting a response cipher based on the speech sounded cipher at the sender end, and comparing the response cipher with the cipher generated at the receiver end so that the receiver end may determine if the incoming call is a VOIP and should be answered.

The above and other objects, features and technical contents will become apparent after the detailed description of the present invention is described through the preferred embodiments taken in conjunction with the accompanying drawings.

### BRIEF DESCRIPTION OF THE DRAWINGS

The invention will become more fully understood from the detailed description given hereinbelow illustration only, and thus does not limit the present invention, wherein:

FIG. 1 is a block diagram depicting an apparatus for prevention of interferences from an incoming call according to the present invention;

FIG. 2 is a flowchart illustrating a method for prevention of interferences from an incoming call according to the present invention; and

FIG. 3 is an illustration of a communications authentication process employed in the method, for prevention of interferences from speech sounds in telephony, according to the present invention.

### DETAILED DESCRIPTION OF THE INVENTION

Since computer telephony integration (CIT) technology has been used more widely, customer service based speech sounds and active advertisement and merchandising associated voice-over-internet-protocol (VOIP) SPAM have considerably grown. To avoid interferences brought by such VOIP SPAM, the present invention provides an apparatus and method for prevention of interferences from speech sounds in telephony.

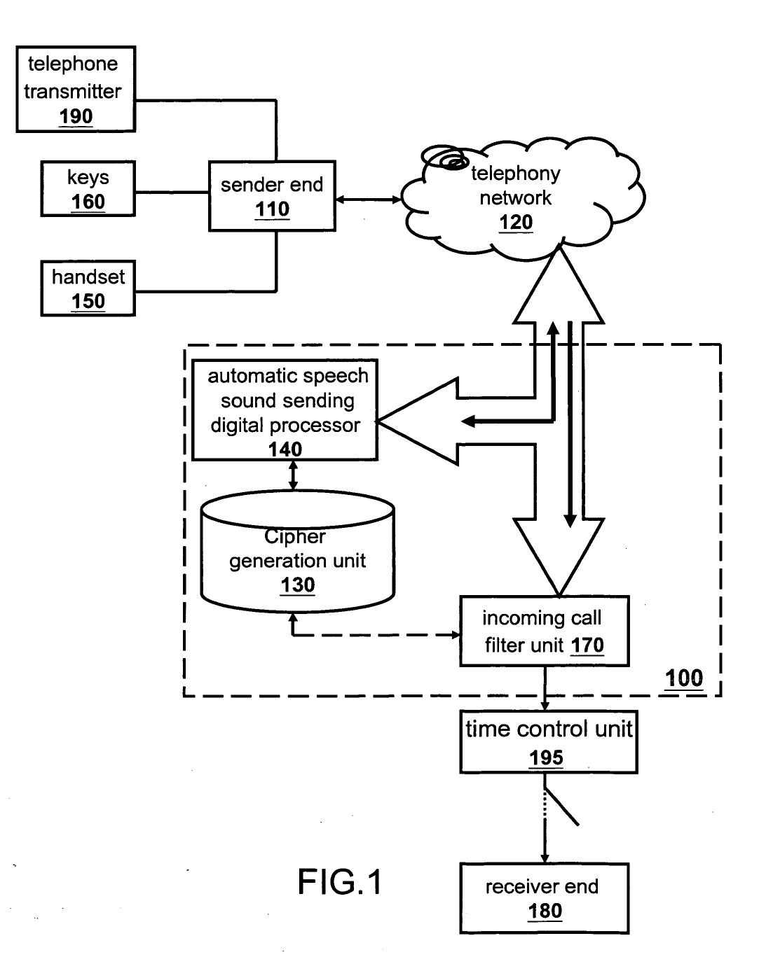

Referring to FIG. 1, a schematic block diagram of the apparatus for prevention of interferences from speech sounds in telephony is shown therein. The apparatus 100 comprises a cipher generation unit 130, an automatic speech sounds sending digital processor 140 and an incoming call filtering unit 170. The cipher generation unit 130 is adapted to generate a cipher based on an incoming call from a sender end 110. The cipher may be randomly generated among integers 0 to 9. Alternatively, any combination of any code which may also be provided by keys of the used apparatus may be taken as the cipher. The automatic speech sounds sending digital processor 140 is adapted to send a speech sounded cipher to the sender end 110 through a telephony network 120 based on the cipher generated by the cipher generation unit 130. The incoming call filtering unit 170 is adapted to compare a response cipher inputted at the sender end 110 with the cipher generated in the cipher generation unit 130. The compared result is used as a reference for determination if the incoming call made from a telephone transmitter 190 at the sender end 110 is VOIP SPAM and should be answered by a receiver 180. Further, the apparatus 100 also includes a time control unit 195, which is adapted to limit a waiting time, beyond which the receiver 180 will not await the receipt of the response cipher and will terminate the incoming call directly.

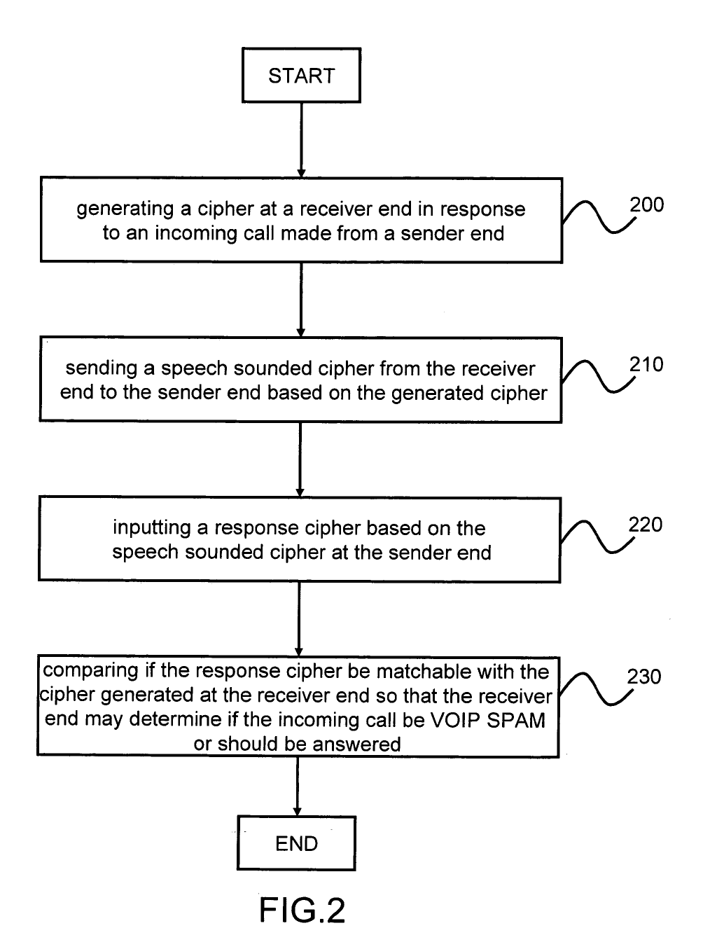

FIG. 2 is a flowchart illustrating a method of filtering VOIP SPAM in telephony, comprising the steps of generating a cipher at a receiver end in response to an incoming call made from a sender end (Step 200); sending a speech sounded cipher from the receiver to the sender based on the generated cipher (Step 210); inputting a response cipher based on the speech sounded cipher at the sender end (Step 220); and comparing if the response cipher is matchable with the cipher generated at the receiver end so that the receiver end may determine if the incoming call is VOIP SPAM or should be answered (Step 230). If the compared result is determined as yes, the receiver may be notified by ringing or vibration. If the sender does not transmit the response cipher correctly to the receiver end within a specific time limit, the apparatus terminates the incoming call actively.

Hereinafter, a preferred embodiment is provided to enable one skilled in the art to better understand the method of the present invention for prevention of interferences from speech sound in telephony. The description will be made with reference to FIG. 1. When the receiver 180 initializes a filtering function, the apparatus 100 automatically picks up an incoming call but no telephone ring is given off. At this time, the cipher generated at the receiver end 180 is transformed into a speech sounded cipher and transmitted to a handset 150 at the sender end 110 through a speech sound function built in the automatic speech sound sending digital processor 140. Now assuming the cipher generation unit 130 generates a cipher “9”, the speech content is ‘Please enter “9” if a real connection is desired’ at this time. In case the incoming call is made by a person, the person may understand the speech sound ‘Please enter ‘9’ if a real connection is desired’ and thus may input “9” on keys 160 in an attempt to communicate with the receiver end 180. As such, the receiver 180 may be notified by telephone ring or vibration and the receiver 180 may actually pick up the incoming call. If the response cipher is determined as erroneous, the apparatus 100 may play the generated cipher again, requesting the sender 110 to enter the proper cipher again. If the proper cipher is not received at the receiver end within a 10 seconds limit, the apparatus 100 terminates the incoming call automatically. In case the incoming call is associated with advertisement speech sounds (e.g. sent by a CTI dialing system), the incoming call will be terminated since the CTI dialing system is not able to identify content in the speech sounded cipher, which makes it impossible to transmit the response cipher. Based on this mechanism, the purpose of avoiding interferences from speech sounds in telephony may be achieved.

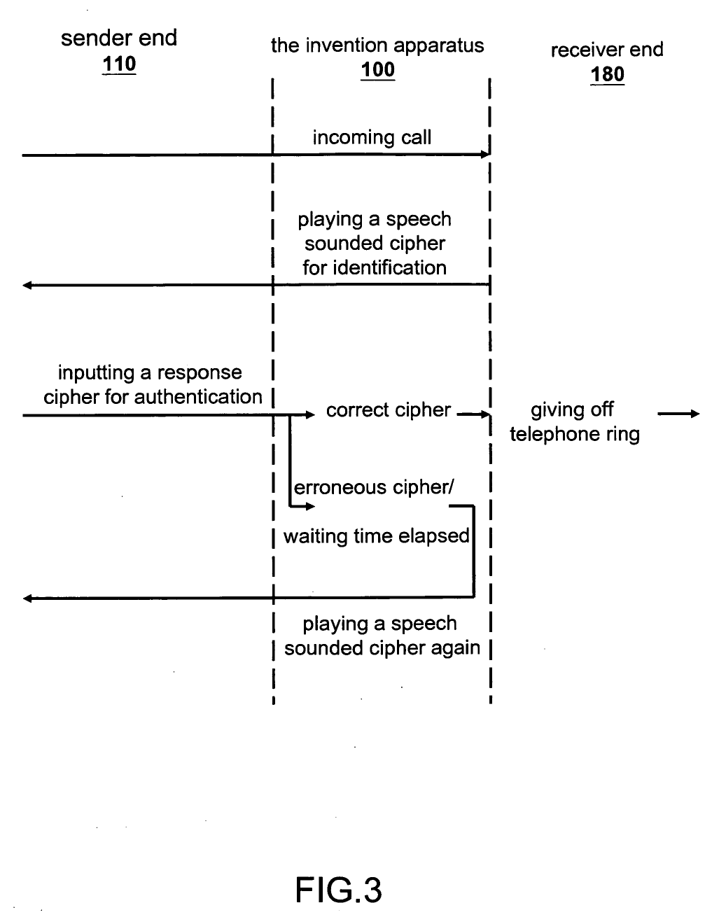

FIG. 3 is an illustration of a communication authentication process employed in the method, for prevention of interferences from speech sounds in telephony. Through this illustration, the conditions in which the telephone ring has to be caused to happen may be clearly and readily understood. Namely, if an incoming call is a normal call or VOIP, SPAM may be determined through the illustrated communication authentication process, so that the purpose of prevention of interferences from speech sounds in telephony may be achieved.

It is to be particularly noted, herein, that the apparatus for prevention of interferences from speech sounds in telephony may be installed in a telephone exchange or a telephone set. In fact, not only general telephones and mobile phones but also large exchange equipped telephony systems may be benefited by the present invention.

While embodiments and applications of this invention have been shown and described, it would be apparent to those skilled in the art, having the benefit of this disclosure that many more modifications than mentioned above are possible without departing from the inventive concepts herein. The invention, therefore, is not to be restricted except in the spirit of the appended claims and their equivalents.

1. An apparatus for prevention of interferences from speech sounds in telephony, comprising:
a cipher generation unit adapted to generate a cipher based on an incoming call from a sender end;
an automatic speech sound sending digital processor adapted to play a cipher speech sound to the sender end; and
an incoming call filter unit adapted to compare a cipher inputted by the sender end with the cipher generated at the receiver end, wherein the compared result is used for a determination as to if the incoming call should be answered.

2. The apparatus of claim 1, wherein the cipher is generated randomly.

3. The apparatus of claim 1, wherein the cipher is a combination of all codes capable of being provided by keys of the apparatus.

4. The apparatus of claim 1, wherein the apparatus is installed in a telephone exchange.

5. The apparatus of claim 1, wherein the apparatus is installed in a telephone set.

6. The apparatus of claim 1, further comprising a time control unit used to limit a waiting time beyond which the response cipher transmitted by the sender end is not accepted.

7. A method for prevention of interferences from speech sound in telephony, comprising the steps of:
generating a cipher at a receiver end in response to an incoming call made from a sender end;
sending a speech sounded cipher from the receiver end to the sender end based on the generated cipher;
inputting a response cipher based on the speech sounded cipher at the sender end; and
comparing if the response cipher be matchable with the cipher generated at the receiver end so that the receiver end may determine if the incoming call should be answered.

8. The apparatus of claim 7, wherein the cipher is generated randomly.

9. The apparatus of claim 7, wherein the cipher is a combination of all codes capable of being provided by keys of the apparatus.

10. The apparatus of claim 7, further comprising a step of limiting a waiting time beyond which the response cipher transmitted by the sender end is not accepted.
